(19) United States
(12) Patent Application Publication
(10) Pub. No.: US 2010/0299107 A1
(43) Pub. Date: Nov. 25, 2010

(54) ACOUSTIC ANALYSIS APPARATUS FOR VEHICLE

(75) Inventors: Takahiro UMAYAHARA, Hiroshima-shi (JP); Yuji EGASHIRA, Hiroshima-shi (JP); Katsuya KAWAGUCHI, Hiroshima-shi (JP)

Correspondence Address: Studebaker & Brackett PC, One Fountain Square, 11911 Freedom Drive, Suite 750, Reston, VA, 20190, US

(73) Assignee: MAZDA MOTOR CORPORATION, Hiroshima (JP)

(21) Appl. No.: 12/722,195

(22) Filed: Mar. 11, 2010

(30) Foreign Application Priority Data
Mar. 27, 2009 (JP) 2009-080286

(51) Int. Cl. G06F 17/50; G06F 17/10

(52) U.S. Cl. 703/1; 703/2

(57) ABSTRACT

Disclosed is an acoustic analysis apparatus. The acoustic analysis apparatus is configured to allow a user or operator to set a plurality of load input points corresponding to respective sound input sources, and an evaluation point for evaluating a level of a sound pressure transferred from each of the set load input points (S1 to S3). Then, the acoustic analysis apparatus is operable to calculate a sound pressure level-frequency characteristic of a sound pressure from each of a plurality of paths between respective ones of the load input points and the evaluation point, by a finite element method (S5), and display the sound pressure level-frequency characteristic obtained by the calculation, in such a manner as to distinguishably indicate a difference in sound pressure level between the respective sound pressures from the paths.

### BACKGROUND OF THE INVENTION

1. Field of the Invention

The present invention relates to an acoustic analysis apparatus for a vehicle, by means of CAE (computer Aided Engineering).

2. Description of the Background Art

CAE has been utilized as effective means to determine structure at each stage of product development, and the use thereof has been expanded/stepped up year by year. A development activity using CAE includes many various tasks, such as a study of reduction in weight, as well as routine tasks of satisfying respective performance targets, and an amount of CAE-based tasks is rapidly increasing. In this situation, as a prerequisite to reliably reflecting a new CAE technique on product development, it is necessary to considering expansion of a CAE-utilization area in conjunction with improvement in equality and productivity of a CAE-based task.

The use of CAE for vehicle development becomes more active than ever before. Particularly, in regard to an analysis of vehicle interior sound (i.e., sound in an internal space of a passenger compartment of a vehicle), there have been known techniques disclosed, for example, in JP 2003-186917A (hereinafter referred to as “Patent Document 1”) and JP 2006-185193A (hereinafter referred to as “Patent Document 2”). Specifically, the Patent Document 1 discloses a technique of calculating airborne sound and structure-borne sound to calculate an acoustic level, using a vehicle model based on 3D-CAD data. The Patent Document 2 discloses a technique of calculating, at a specific pre-input frequency of interest, a contribution rate of a vibration transmission capability of each region of a structure to an acoustic level to be generated at an evaluation position when a vibration input point of the structure is vibrated.

However, the conventional CAE-based acoustic analysis techniques are designed to perform an acoustic analysis only at a specific frequency. Thus, there is a problem that an acoustic analysis cannot be performed based on a sound-pressure distribution characteristic figured out in a given frequency range.

It is therefore an object of the present invention to an acoustic analysis apparatus for a vehicle, capable of performing a detailed acoustic analysis at a specific frequency while figuring out a sound-pressure distribution characteristic over a given acoustic frequency range.

### SUMMARY OF THE INVENTION

In accordance with one aspect of the present invention, there is provided an acoustic analysis apparatus for a vehicle, which comprises: a load setting section operable, in response to a user's instruction, to set, onto a structure representing the vehicle, a plurality of load input points corresponding to respective sound input sources; an evaluation-point setting section operable, in response to a user's instruction, to set, within a vehicle interior space of the structure, an evaluation point for evaluating a level of a sound pressure transferred from each of the set load input points; a calculation section operable to calculate a sound pressure level-frequency characteristic of a sound pressure from each of a plurality of paths between respective ones of the load input points and the evaluation point, over a given frequency range by a finite element method; and a display section operable to display the sound pressure level-frequency characteristic obtained by the calculation section, in such a manner as to distinguishably indicate a difference in sound pressure level between the respective sound pressures from the paths, at each frequency in the given frequency range.

The acoustic analysis apparatus of the present invention makes it possible to perform a detailed analysis at a specific frequency, while figuring out a sound-pressure distribution characteristic over a given acoustic frequency range.

These and other objects, features and advantages of the present invention will become apparent upon reading of the following detailed description along with the accompanied drawings.

### BRIEF DESCRIPTION OF DRAWINGS

FIG. 1 is a diagram showing a schematic configuration of a computer system realizing a vehicle acoustic analysis apparatus according to one embodiment of the present invention.

FIG. 2 is a diagram showing one example of contents stored in a hard disk drive in the embodiment.

FIG. 3 is a flowchart showing a process of creating data by the vehicle acoustic analysis apparatus according to the embodiment.

FIG. 4 is a diagram showing one example of an evaluation condition-setting screen in the embodiment.

FIG. 5 is a conceptual diagram of a sound pressure component at a load input point.

FIG. 6 is a conceptual diagram of a contribution of the sound pressure component at the load input point to a total sound pressure.

FIG. 7 is a conceptual diagram of a sound pressure component at each of an evaluation point k and a structure/sound coupling point j.

FIG. 8 is a conceptual diagram of a contribution of the sound pressure component at the structure/sound coupling point j to the total sound pressure.

FIG. 9 is a conceptual diagram of a sound pressure component in a panel region.

FIG. 10 is a conceptual diagram of a contribution of the sound pressure component in the panel region to the total sound pressure.

FIG. 11 is a conceptual diagram of a sound pressure component in an acoustic mode m.

FIG. 12 is a conceptual diagram of a contribution of the sound pressure component in the acoustic mode m to the total sound pressure.

FIG. 13 is a diagram showing one example of a path analysis screen in the embodiment.

FIGS. 14A and 14B are diagrams showing one example of a panel contribution analysis screen in the embodiment.

FIG. 15 is a diagram showing one example of a panel-region contribution analysis screen in the embodiment.

FIG. 16 is a diagram showing one example of an acoustic-mode contribution rate analysis screen in the embodiment.

### DESCRIPTION OF THE INVENTION

With reference to the drawings, the present invention will now be specifically described based on a preferred embodiment thereof. The following embodiment is not intended to limit the present invention thereto, but shown and described simply by way of illustration suited to actually carry out the invention. Further, a combination of features described in the following embodiment is not always entirely essential as means to achieve the object of the present invention

While a vehicle acoustic analysis apparatus according to this embodiment may be realized using dedicated hardware and logic, it can nowadays be realized using a general-purpose computer system sufficiently at a practical level. Specifically, in view of computing capacities of recent computers, they are normally capable of performing processing of a finite element model having over one million elements/nodes and modeling of almost all vehicle body members and components using shell and solid elements having a mesh size of 5 mm or 10 mm

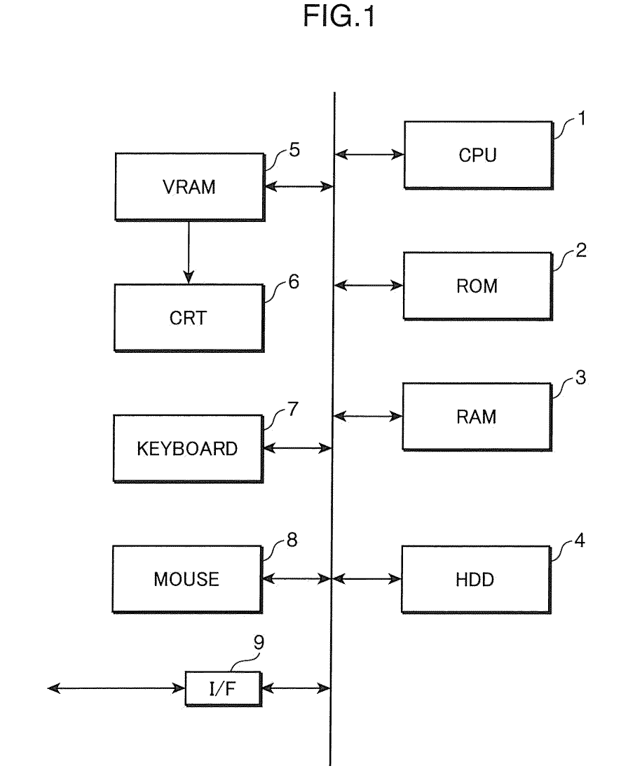

FIG. 1 is a diagram showing a schematic configuration of a computer system realizing the vehicle acoustic analysis apparatus according to this embodiment. The illustrated computer system comprises a CPU 1 adapted to govern a control of the entire system, a ROM 2 storing a boot program, fixed data and others, a ROM 3 functioning as a main memory, and the following components.

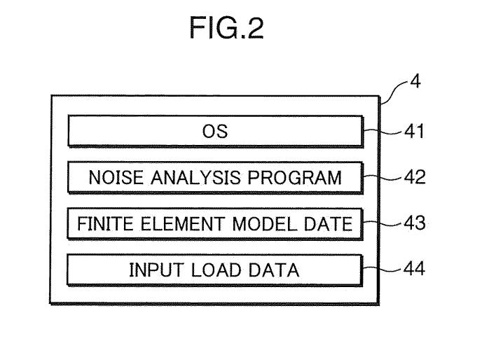

A hard disk drive (HDD) 4 serving as a secondary storage device stores therein an operating system (OS) 41, an acoustic analysis program 42, finite element model date 43, input load data 44 and others, as shown in FIG. 2. Further, the HDD 4 is adapted to store therein various finite element calculation results created by executing the acoustic analysis program 42.

A video RAM (VRAM) 5 is adapted to expand image data, and a CRT 6 as one example of an image display unit is adapted to display thereon the expanded image data and others. The reference numerals 7 and 8 are, respectively, a keyboard and a mouse each serving as an input device. The computer system is capable of communicate with an external apparatus through an interface (I/F) 9.

In the above computer system, the acoustic analysis program 42 is started, for example, in response to a specific instruction event from the keyboard 7 or the mouse 8. In this timing, the acoustic analysis program 42 is loaded into the RAM 3, and then executed by the CPU 1. In this manner, the computer system becomes operable as the vehicle acoustic analysis apparatus.

It is understood that the computer system may be a client/server network system, instead of a stand-alone type as described above.

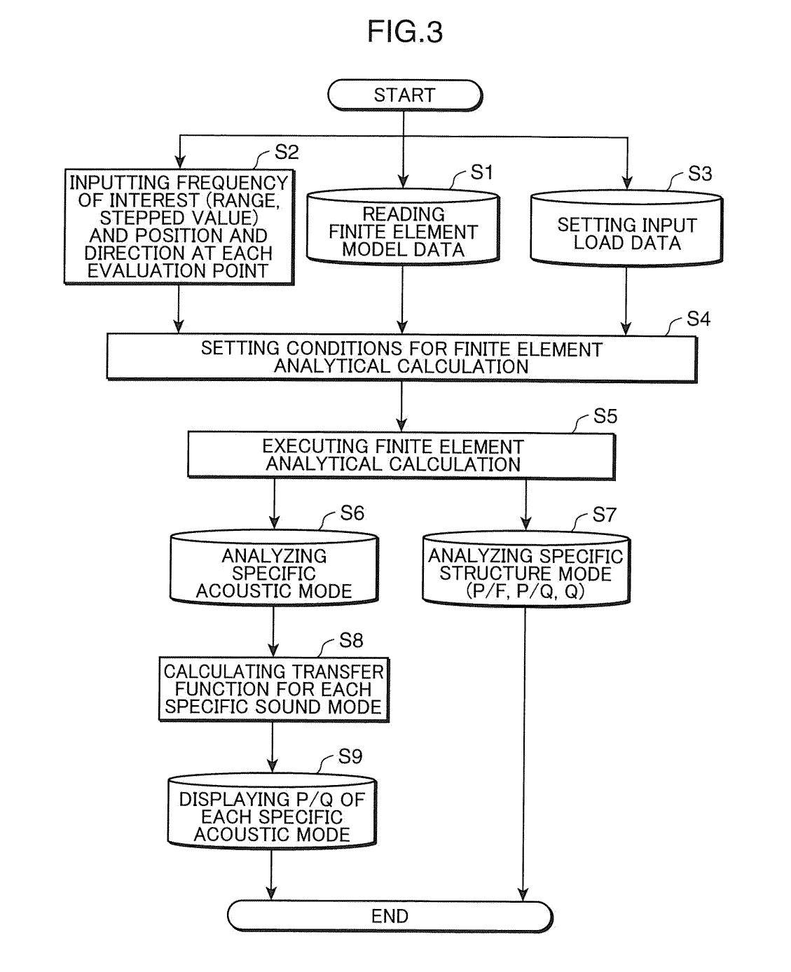

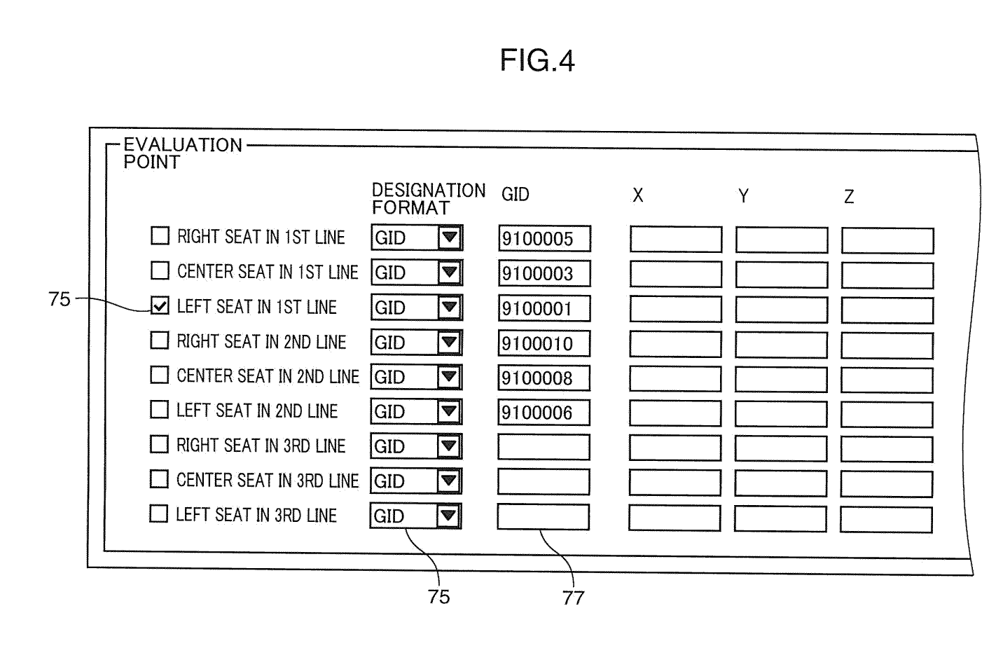

FIG. 3 is a flowchart showing a process of creating data by the vehicle acoustic analysis apparatus according to this embodiment. With reference to this flowchart and FIGS. 4 to 16, an operation of the vehicle acoustic analysis apparatus according to this embodiment will be specifically described below.

The vehicle acoustic analysis apparatus according to this embodiment is a CAE process automation system designed for the purpose of:
automating a process of a routine analytic task;
interactively displaying a finite element calculation result using various analytical techniques to efficiently facilitate understanding phenomena and determining a direction of countermeasure; and
serving as a basis (platform) for analysis standards and new technologies.

The vehicle acoustic analysis apparatus according to this embodiment is designed to evaluate noise due to an input load, for example, to be applied from a suspension or an engine mount to a vehicle body, and equipped with low-frequency vibration, such as an analyzer for idle vibration and lock-up vibration, and an analyzer for mid-frequency vibration, such as muffled sound and road noise.

[Home Screen]

Upon staring the acoustic analysis program 42, a home screen is displayed on the CRT 6. The home screen comprises a process-tree block, and an arbitrary number of job-form blocks for displaying various analysis results. The process-tree block displays a sequence of unit items of a task process in a tree form. The job-form block provides a graphical user interface (GUI) for performing a model definition, a calculation submitting, an evaluation/analysis of a calculation result, etc. A content of the job-form block can be stored, for example, as extensible markup language (XML) data. One of the items or tabs in the process-tree block can be selected (clicked by the mouse 8) to switch to a corresponding one of the following data setting screens.

[Target Setting Screen]

Upon selecting an item “Target setting-Target setting” in the process-tree block, a target setting screen is displayed. By use of the target setting screen, a target value of a sound level is input. As a target-value input operation, the target value is input in association with after-mentioned one or more evaluation positions (e.g., an ear position; hereinafter referred to as “evaluation point” or “sound-pressure evaluation point”). A vehicle-traveling speed (vehicle speed) at which the target value is to be achieved may be input in combination therewith. Further, for each evaluation point (e.g., ear point), the target value may be input in the form of a target line as a function to an engine speed.

[Model Definition Screen]

Upon selecting an item “Calculation execution-Model definition” in the process-tree block, a model definition screen is displayed. By use of the model definition screen, structure model data (e.g., Nastran file) for use in calculation is read out as an include file (Step S1 in FIG. 3).

[Evaluation-Condition Setting Screen]

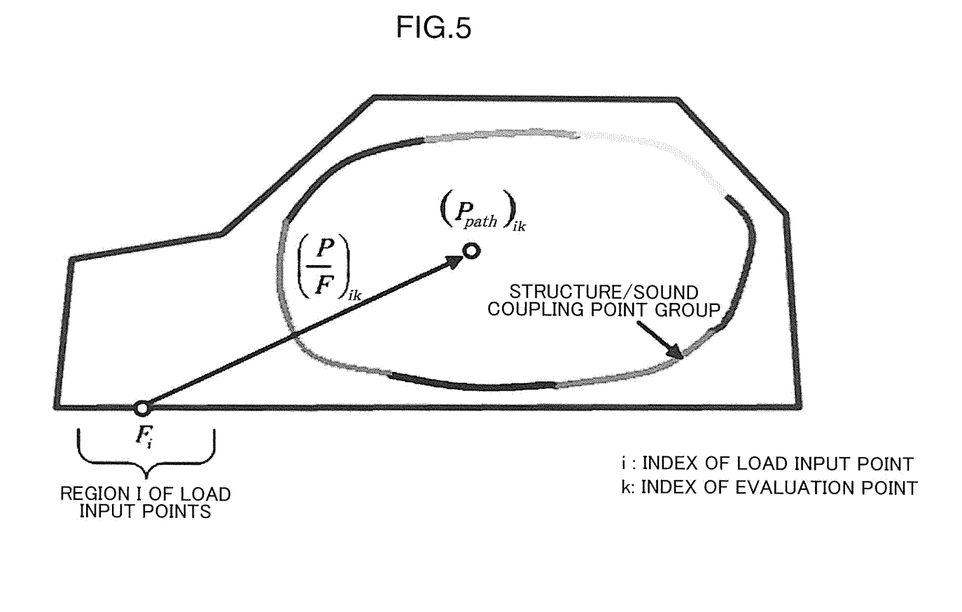

Upon selecting an item “Calculation execution-Evaluation condition setting” in the process-tree block, an evaluation-condition setting screen is displayed. By use of the evaluation-condition setting screen, an actual load and an evaluation point are set (Steps S2 and S3 in FIG. 3). In the operation of setting the actual load, a file of measured data pre-acquired by an experimental test or calculated data pre-obtained by calculation is read out to input and set a load (Fi in FIGS. 5, 7 and 9) at a node i in each of a large number of grids set on a structure representing a vehicle. In the operation of setting the evaluation point k within a vehicle interior space (i.e., in an internal space of a passenger compartment of a vehicle), one of a plurality of check boxes 75 is marked to select a position corresponding to an ear position of a seated occupant. Then, an evaluation-point designation format is selectively input into an associated box 76, and a node number (GID) or three-dimensional coordinate data is input into an associated box 77. In this case, the evaluation point k may be set at a plurality of nodes.

[Calculation-Condition Setting Screen]

Upon selecting an item “Calculation execution-Calculation condition setting” in the process-tree block is selected, a calculation-condition setting screen is displayed. By use of the calculation-condition setting screen, parameter cards, conditions for an eigen-value analysis and conditions for a frequency response analysis are set (Step S4 in FIG. 3).

[Calculation Submitting Screen]

Upon selecting an item “Calculation execution-Calculation Submitting” in the process-tree block, a calculation submitting screen is displayed. By use of the calculation submitting screen, a project code, a task ID, a stage and others are selected or designated. Then, a button “Calculation Start” is clicked to start an execution of a finite element calculation under the set conditions (Step S5 in FIG. 3). In Step S6, acoustic eigen-modes are to be obtained and in Step S7, structural eigen-modes P/F, P/Q, Q are to be obtained. After obtaining the acoustic eigen-modes in S6, a transfer function is calculated with respect to each eigen-mode in step S8, and thereafter P/Q is obtained with respect to each acoustic eigen-mode in step S9.

[Contents of Finite Element Calculation]

In the finite element calculation in Step S5, the following calculations are performed. Each calculation result will be stored in the HDD 4.

<Sound Pressure Component at Load Input Point>

FIG. 5 is a conceptual diagram of a sound pressure component at each of a load input point i and the evaluation point k. As used herein, the term “load input point” means a point (position) at which an external load (vibration) is input to an evaluation target, i.e., a structure to be subjected to evaluation of acoustic characteristics. In other words, it is assumed that sound is generated by an input of load (vibration). For example, in cases where it is necessary to evaluate acoustic characteristics of a structural member of a vehicle body comprising a body panel and a body frame, except suspensions and tires, the load input point is set at a position (circle mark adjacent to the code Fi in FIG. 5) of the body frame to which a suspension mount is mounted to the vehicle body to serve as a coupling point between the suspension and the vehicle body. Further, in cases where it is necessary to evaluate the entire vehicle including tires, the load input point is set at each mounting position of the tires, although it is not described as a specific embodiment in this specification. As above, the load input point varied depending on a type of evaluation target. A load-input-point sound pressure component to be generated by the load input point i and transferred to the evaluation point k when a load Fi is input into the load input point i, is calculated by the following formula (1-1):

$${( {P}_{path} )}_{ik} = {w}_{i} {{F}_{i} ( \frac{P}{F} )}_{ik} \qquad ( 1 \text{-} 1 )$$

where:
F is a load;
P is a sound pressure;
Wi is a scale coefficient for the load input point i;
Fi is a load (N) input into the load input point i; and

$${( \frac{P}{F} )}_{jk}$$

is a transfer function (MPa/N) in a path from the load input point i to the sound-pressure evaluation point k.

The transfer function

$${( \frac{P}{F} )}_{jk}$$

is a function depending on the load input point i, the sound-pressure evaluation point k and an acoustic frequency, and obtained from pre-measured data or by calculation.

A total sound pressure to be generated by a region I (consisting of a set of indexes of a plurality of the load input points i) and transferred to the evaluation point k is calculated by the following formula (1-2):

$${( {P}_{sum} )}_{k} = {\sum }_{i ∈ I} {( {P}_{path} )}_{ik} \qquad ( 1 \text{-} 2 )$$

where I: a set of indexes of load I/P points

For example, in cases where the evaluation target is the structural member of the vehicle body comprising a body panel and a body frame, the region I is the body frame to which a suspension mount is mounted to the vehicle body to serve as a coupling point between the suspension and the vehicle body.

<Contribution Rate of Sound Pressure Component at Load Input Point>

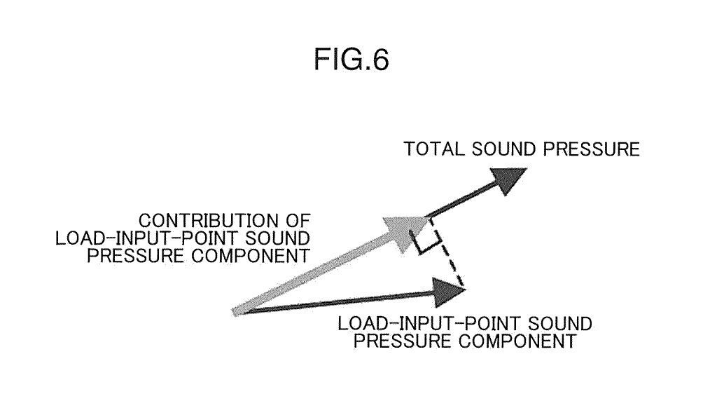

FIG. 6 is a conceptual diagram showing a contribution of a sound pressure component at the load input point i to the total sound pressure. As for a vibrational wave which generates a sound pressure, it is necessary to consider “amplitude” and “phase”. For example, in cases where each of a vibrational wave in a body panel A and a vibrational wave in a body panel B has the same amplitude, if a phase difference between the two vibrational waves is 180 degrees, the total sound pressure becomes zero. Otherwise, if the phase difference is zero degree, the total sound pressure becomes twice. Thus, as seen in FIG. 6, the contribution to the total evaluation point-directed sound pressure is calculated in consideration of not only amplitude but also phase.

The contribution of the sound pressure component at the load input point i to the total sound pressure is calculated in consideration of phase by the following formula (1-3), as a total sound pressure-contributing directional-component of the load-input-point sound pressure component:

Cᵢₖ=|(Pₚₐₜₕ)ᵢₖ|cos [arg{(Pₛᵤₘ)ₖ}−arg {(Pₚₐₜₕ)ᵢₖ}] (1-3))

A contribution rate is obtained by dividing the total sound pressure-contributing directional-component by the total sound pressure.

<Sound Pressure Component at Structure/Sound Coupling Point>

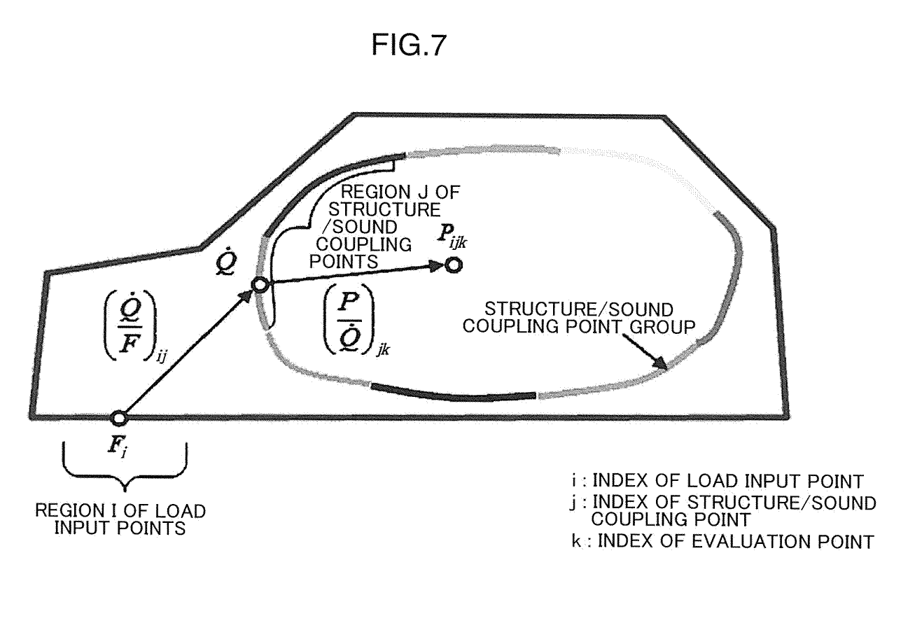

FIG. 7 is a conceptual diagram of a sound pressure component at each of the evaluation point k and a structure/sound coupling point j. As used herein, the term “structure/sound coupling point” means a position at which the body panel defining a vehicle interior space is in contact with air in the vehicle interior space.

A structure/sound-coupling-point sound component to be generated by the structure/sound coupling point j and transferred to the evaluation point k when a load Fi is input into the load input point i in the region I, is calculated by the following formula (2-1):

$${( {P}_{couple} )}_{jk} = {w}_{j} {\sum }_{i ∈ I} {P}_{ijk} \\ {P}_{ijk} = {{F}_{i} ( \frac{{Q}^{′}}{F} )}_{ij} {( \frac{P}{{Q}^{′}} )}_{jk} \qquad ( 2 \text{-} 1 )$$

where:
Wⱼ is a scale coefficient for the structure/sound coupling point j;
I is a set of indexes of the plurality of load input points;
Fi is a load (N) input into the load input point i;
Q is a volume acceleration in a body panel which is vibrating air in the vehicle interior space;

$${( \frac{{Q}^{′}}{F} )}_{ij}$$

is a transfer function (mm³/s²/N) in a path from the load input point i to the structure/sound coupling point j; and

$${( \frac{P}{{Q}^{′}} )}_{jk}$$

is a transfer function (MPa/mm³/s²) in a path from the structure/sound coupling point j to the sound-pressure evaluation point k.

The transfer function

$${( \frac{{Q}^{′}}{F} )}_{ij}$$

is a function depending on the load input point i, the structure/sound coupling point j and an acoustic frequency, and the transfer function

$${( \frac{P}{{Q}^{′}} )}_{jk}$$

is a function depending on the structure/sound coupling point j, the sound-pressure evaluation point k and an acoustic frequency. Each of the transfer functions is obtained from pre-measured data or by calculation.

A total sound pressure to be generated by a region J (consisting of a set of indexes of a plurality of the structure/sound coupling points j) and transferred to the evaluation point k, is calculated by the following formula (2-2):

$${( {P}_{sum} )}_{k} = {\sum }_{j ∈ I} {( {P}_{couple} )}_{jk} \qquad ( 2 \text{-} 2 )$$

<Contribution Rate of Structure/Sound Coupling Point>

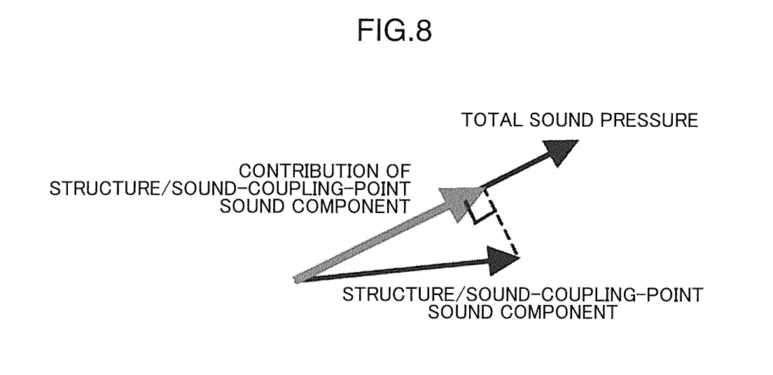

FIG. 8 is a conceptual diagram showing a contribution of a sound pressure component at the structure/sound coupling point j to the total sound pressure.

The contribution of the sound pressure component at the structure/sound coupling point j to the total sound pressure is calculated in consideration of phase by the following formula (2-3), as a total-sound-pressure-contributing directional-component of the structure/sound-coupling-point sound pressure component:

Cⱼₖ=|(P_{couple})ⱼₖ|cos [arg{(Pₛᵤₘ)ₖ}−arg {(P_{couple})ⱼₖ}] (2-3)

A contribution rate is obtained by dividing the total sound pressure-contributing directional-component by the total sound pressure.

<Sound Pressure Component in Panel Region>

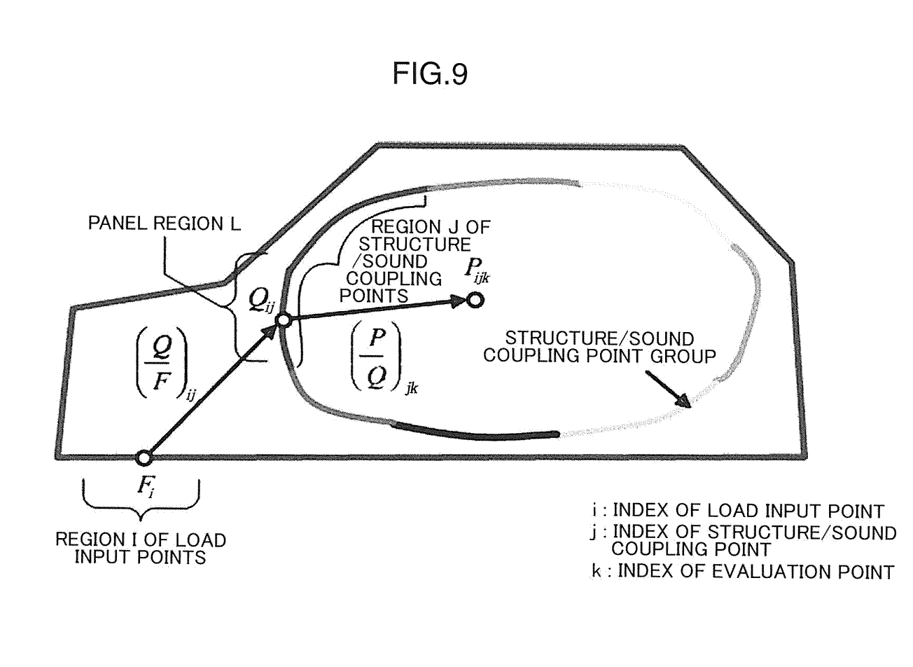

FIG. 9 is a conceptual diagram of a sound pressure component in each of a panel region l consisting of a subset of the structure/sound coupling point region J, and the evaluation point k.

A panel-region sound pressure component to be generated by the panel region l and transferred to the evaluation point k when a load Fi is input into the load input point i, is calculated by the following formula (3-1):

$${( {P}_{panel} )}_{kl} = {w}_{l} {\sum }_{i ∈ I} {\sum }_{j ⋐ {j}_{1}} {P}_{ijk} \\ {P}_{ijk} = {{F}_{i} ( \frac{{Q}^{′}}{F} )}_{ij} {( \frac{P}{{Q}^{′}} )}_{jk} \qquad ( 3 \text{-} 1 )$$

where:
Wₗ is a scale coefficient for the panel region l;
I is a set of indexes of the plurality of load input points;
J is a set of indexes of a plurality of the structure/sound coupling points;
Jₗ is a subset of the set J of indexes of the structure/sound coupling points in the panel region l;

Fi is a load (N) input into the load input point i;

$${( \frac{{Q}^{′}}{F} )}_{ij}$$

is a transfer function (mm³/s²/N) in a path from the load input point i to the structure/sound coupling point j; and

$${( \frac{P}{{Q}^{′}} )}_{jk}$$

is a transfer function (MPa/mm³/s²) in a path from the structure/sound coupling point j to the sound-pressure evaluation point k.

The transfer function

$${( \frac{{Q}^{′}}{F} )}_{ij}$$

and the transfer function

$${( \frac{P}{{Q}^{′}} )}_{jk}$$

are the same as those in the formula (2-1).

A total sound pressure to be generated by a region L (consisting of a set of indexes of a plurality of the panel regions l) and transferred to the evaluation point k is calculated by the following formula (3-2):

$${( {P}_{sum} )}_{k} = {\sum }_{I ∈ L} {( {P}_{panel} )}_{kl} \qquad ( 3 \text{-} 2 )$$

<Contribution Rate of Panel Region>

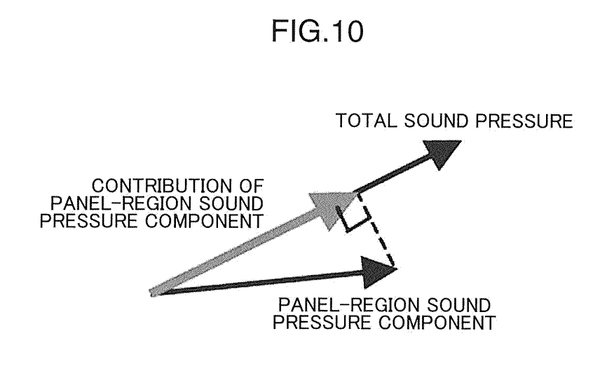

FIG. 10 is a conceptual diagram of a contribution of the sound pressure component in the panel region l to the total sound pressure.

The contribution of the sound pressure component in the panel region l to the total sound pressure is calculated in consideration of phase by the following formula (3-3), as a total sound pressure-contributing directional-component of the panel-region sound pressure component:

Cₖₗ=|(Pₚₐₙₑₗ)ₖₗ|cos [arg{(Pₛᵤₘ)ₖ}−arg {(Pₚₐₙₑₗ)ₖₗ}] (3-3)

A contribution rate is obtained by dividing the total sound pressure-contributing directional-component by the total sound pressure.

<Sound Pressure Component in Acoustic Mode>

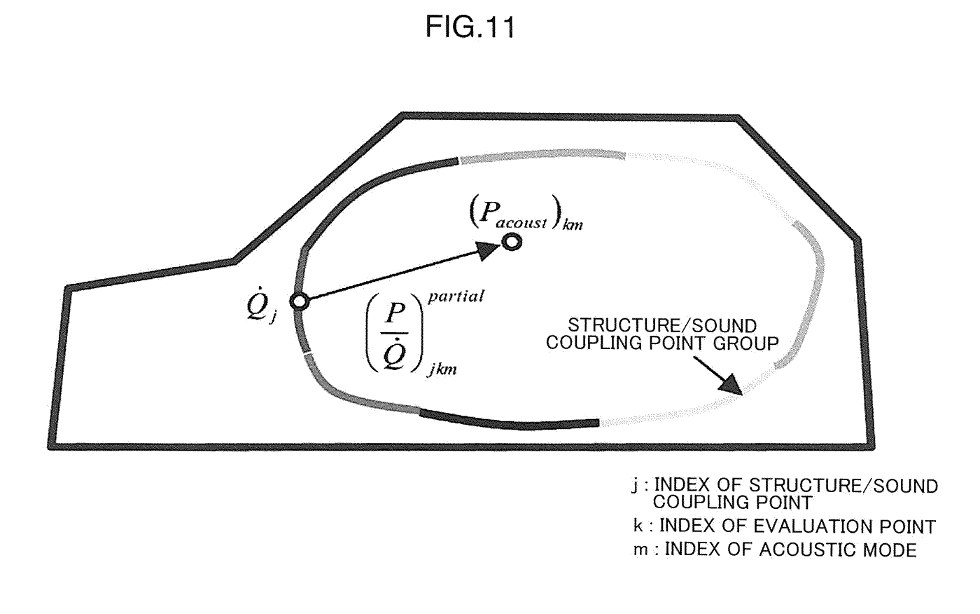

FIG. 11 is a conceptual diagram of a sound pressure component in each of an acoustic mode m and the evaluation point k.

Sound is generated by vibration of air in the vehicle interior space, which is caused by a load input into the load input point of the structural member of the vehicle body and transferred through various paths. A vibrational wave causing the sound consists of a large number of vibrational waves superimposed together, the number (per unit time) of “anti-nodes” where an amplitude of the vibration wave becomes maximum and the number (per unit time) of “nodes” where the amplitude of the vibration wave becomes almost zero are different (i.e., a “frequency”) is different in each of a plurality of groups of the vibrational waves. The groups of vibrational waves different in the number of “anti-nodes” and the number of “nodes” are distinguished from each other, and listed in descending order of the contribution rate, as an “acoustic mode”.

An acoustic-mode sound pressure component to be generated by the acoustic mode and transferred to the evaluation point k when volume accelerations Q′j of the acoustic mode m are coupled together at the structure/sound coupling point j, is calculated by the following formula (4-1):

$${( {P}_{acoust} )}_{km} = {w}_{m} {\sum }_{j ∈ J} {( \frac{P}{{Q}^{′}} )}_{jkm}^{partial} {Q}_{j}^{′} \\ {Q}_{j}^{′} = {\sum }_{j ∈ J} {F}_{j} ( \frac{{Q}^{′}}{F} ) ij \qquad ( 4 \text{-} 1 )$$

where:
Wm is a scale coefficient for the acoustic mode m;
I is a set of indexes of the plurality of load input points;
J is a set of indexes of the plurality of structure/sound coupling points;
Fi is a load (N) input into the load input point i;

$${( \frac{{Q}^{′}}{F} )}_{ij}$$

is a transfer function (mm³/s²/N) in a path from the load input point i to the structure/sound coupling point j; and

$${( \frac{P}{{Q}^{′}} )}_{jkm}^{partial}$$

is a transfer function (MPa/mm³/s²) in a path from the structure/sound coupling point j to the sound-pressure evaluation point k in cases where only the acoustic mode m is used.

The transfer function

$${( \frac{P}{{Q}^{′}} )}_{jkm}^{partial}$$

is a function depending on the structure/sound coupling point j, the evaluation point k and an acoustic frequency, and obtained from pre-measured data or by calculation.

A total sound pressure to be generated by a set M of indexes of a plurality of the acoustic modes m and transferred to the evaluation point k is calculated by the following formula (4-2):

$${( {P}_{sum} )}_{k} = {\sum }_{m ∈ M} {( {P}_{acoustic} )}_{km} \qquad ( 4 \text{-} 2 )$$

<Contribution Rate of Acoustic Mode>

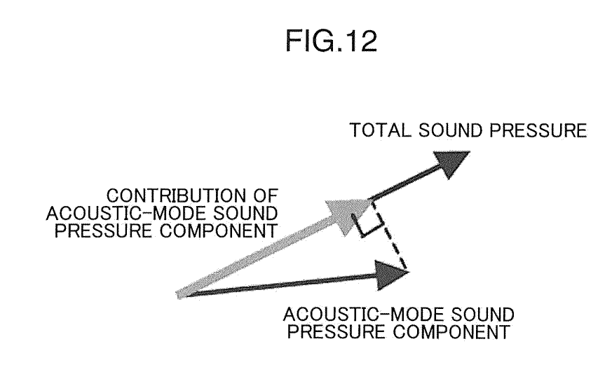

FIG. 12 is a conceptual diagram of a contribution of a sound pressure component of the acoustic mode m to the total sound pressure.

The contribution of the sound pressure component of the acoustic mode m to the total sound pressure is calculated in consideration of phase by the following formula (4-3), as a total sound pressure-contributing directional-component of the acoustic-mode sound pressure component.

Cₘₖ=|(P_{acoust})ₖₘ|cos [arg{(Pₛᵤₘ)ₖ}−arg {(P_{acoust})ₖₘ}] (4-3)

A contribution rate is obtained by dividing the total sound pressure-contributing directional-component by the total sound pressure.

The contents of the finite element calculation in Step S5 are generally as described above.

A process of displaying a calculation result obtained in the above manner will be described below.

[Path Analysis Screen]

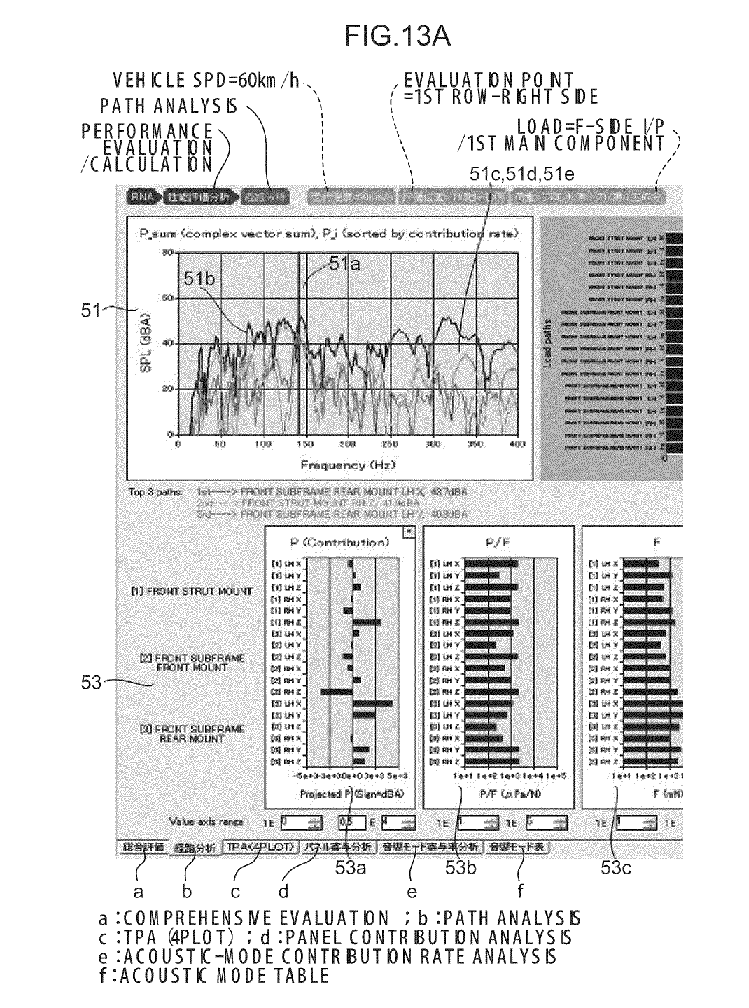

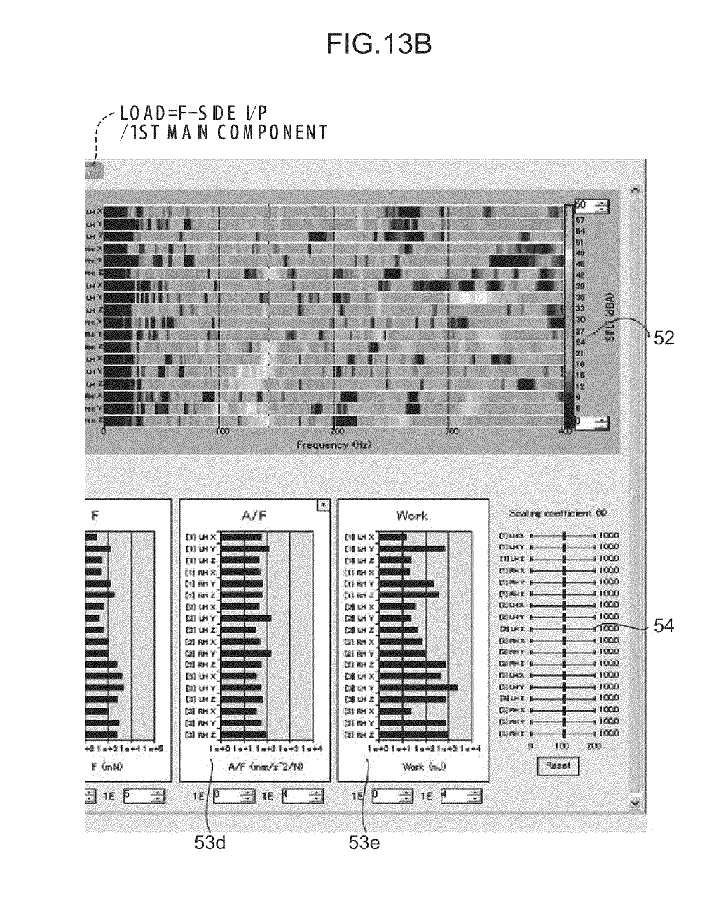

Upon selecting an item “Performance evaluation/analysis-Path analysis” in the process-tree block, a path analysis screen as shown in FIG. 13 is displayed.

As used herein, the term “path” is a path having a very common and general meaning. For example, a load Fi (=vibration) input from a load input point i in a vehicle body frame mounting a suspension mount is transferred to a panel defining the vehicle interior space (vehicle interior space-defining panel), via various “paths”. Each of such transfer paths is termed as the “path”.

As a specific example, the path includes:

a path 1: load input point→- - - - -→vehicle interior space-defining panel (floor panel);

a path 2: load input point→front subframe (X-direction)→- - - - -→vehicle interior space-defining panel (dash panel); and

a path 3: load input point→front subframe (Y-direction)→- - - - -→vehicle interior space-defining panel (dash panel)

An SPL-frequency curve display section 51 is displayed on a left upper side of the path analysis screen to indicate a sound pressure level (SPL) at an evaluation point, over a given frequency range. The SPL-frequency curve display section 51 is configured to display an SPL-frequency curve 51b of a total sound pressure obtained by adding sound pressures from all paths on an assumption that the region I in the formula (1-2) is the entire region of a body frame, and a load is input into all load input points in the region I. In the SPL-frequency curve display section 51, when a cursor 51a is placed at a position of a specific frequency, a contribution of the sound pressure from each of the paths is calculated by the formulas (1-1), (1-2), (1-3) using the specific frequency as a frequency-dependent transfer function. Then, top three of the paths in terms of the contribution at the specific frequency are selected, and three SPL-frequency curves 51c, 51d, 51e are displayed to indicate frequency characteristics of respective sound pressures from the top-three paths, over the given frequency range. Thus, based on an operation of changing a position of the cursor 51a, three SPL-frequency curves 51c, 51d, 51e for top-three paths in terms of the contribution at a specific frequency designated by the cursor can be displayed. For example, the SPL-frequency curve display section 51 can be used to identify an input source having a high contribution to sound to be transferred from an engine mount and a suspension to a vehicle body.

On a right side of the SPL-frequency curve display section, another display section is displayed to indicate a sound spectrum 52 for each of the sound input paths. The sound spectrum 52 makes it possible to readily analyze a sound input source at each frequency.

Further, five display sections are displayed in a lower region 53 of the path analysis screen, wherein a contribution rate of P (sound pressure) 53a, a contribution rate of P/F (point inertance (sound pressure/load input)) 53b representing a sensibility to a load input, a contribution rate of F (load input) 53c, a contribution rate of A/F (vehicle body sensitivity characteristics) 53d representing a panel displacement to a load input, and a contribution rate of Work (work amount) 53e representing an amount of energy generated by the panel displacement, at a specific frequency indicated by the cursor 51a in the SPL-frequency curve display section 51, are indicated in respective ones of the display sections, with respect to each path, e.g., for each of a path from a front strut mount and a path from a front subframe (and further with respect to each direction, e.g., for each of an X-direction, a Y-direction and a Z-direction), and in the form of a bar graph.

Among them, the P (sound pressure) 53a is calculated by the formulas (1-1), (1-2), (1-3), and the F (load input) 53c is calculated by adding input data on a path-by-path basis. The P/F (point inertance (sound pressure/load input)) 53b is calculated by dividing the P (sound pressure) by the F (load input).

Further, a scaling coefficient setting section 54 is displayed on a right side of the lower display sections. A slide drive provided in the scaling coefficient setting section 54 can be moved in a rightward-leftward direction to change a scaling coefficient to allow the P (sound pressure) for each path to be re-calculated and re-displayed when a value of the P (sound pressure) for each path is changed. The change of the scaling coefficient corresponds to changing the scale coefficient Wi in the formula (1-1). Thus, a contribution corresponding to this change is re-calculated by the formulas (1-1), (1-2), (1-3), and then an SPL-frequency curve 51b for a total sound pressure, three SPL-frequency curves 51c, 51d, 51e for the top-three paths, sound spectra 52, P (sound pressure) 53a and P/F (point inertance (sound pressure/load input)) 53b each changed due to the change of the scaling coefficient are re-indicated.

In the above manner, an influence of a change in load input value, a change in sensibility of a vehicle body, or a change in rigidity of a mounting member of the vehicle body, can be checked to facilitate identifying path characteristics exerting an influence on vehicle interior sound, and estimate a change in sound characteristics when measures for suppressing a sound pressure are taken on a path-by-path basis.

[Panel Contribution Analysis Screen]

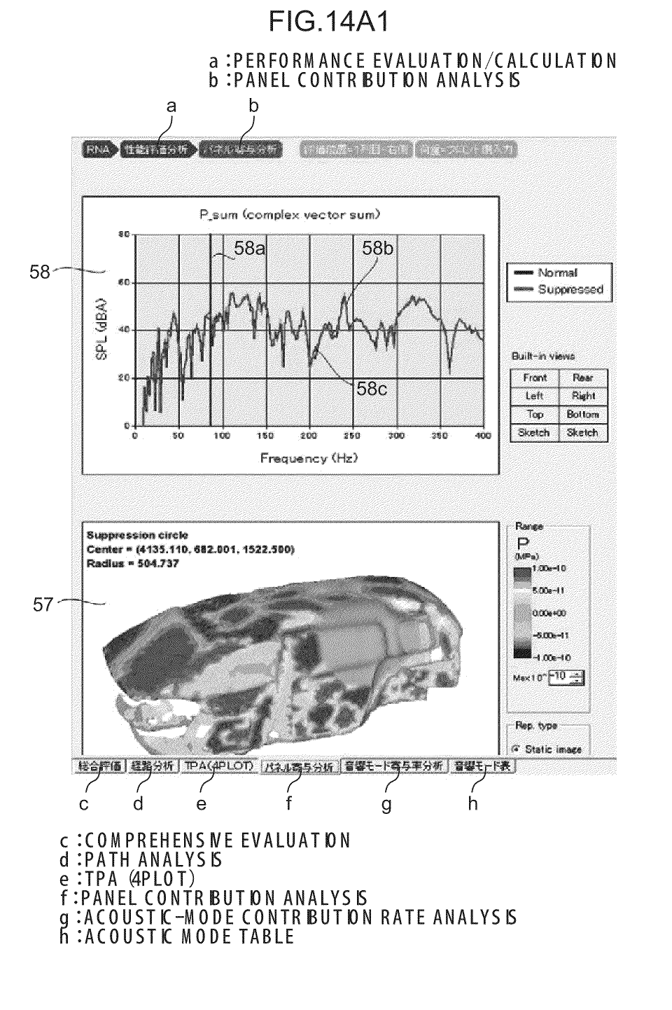

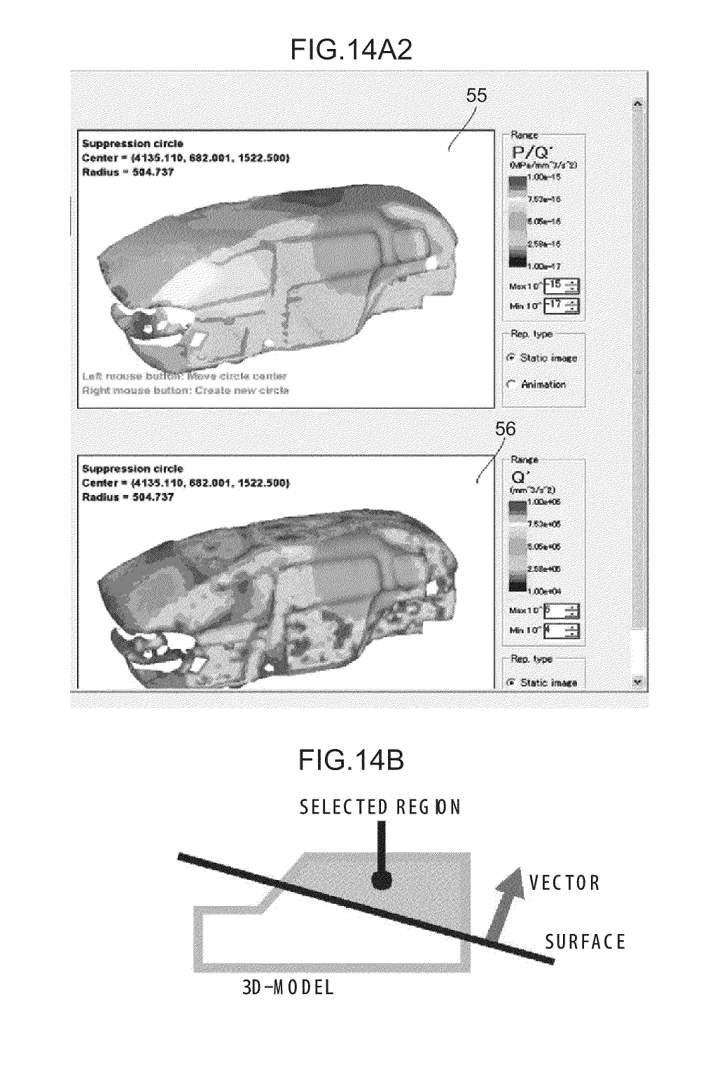

Upon selecting an item “Performance evaluation/analysis-Panel contribution analysis” in the process-tree block, a panel contribution analysis screen as shown in FIG. 14A is displayed.

The panel contribution analysis screen has a P/Q′ display section 55 for displaying an acoustic radiation coefficient (P/Q′) representing a panel having a potential to generate sound, a Q′ display section 56 for displaying a volume acceleration (Q′) representing a panel which is vibrating air in the vehicle interior space, and a P display section 57 for displaying a contribution rate of each panel to a sound pressure (P), which is calculated by multiplication of the acoustic radiation coefficients (P/Q′) and the volume accelerations (Q′).

As used herein, the term “panel likely to generate sound” generally means a panel which resonates with a vehicle interior space or cavity at an arbitrary frequency to generate large sound.

Further, as with the path analysis screen, an SPL-frequency curve display section 58 is displayed on a left upper side of the panel contribution analysis screen, to indicate an SPL-frequency curve 58b of a total sound pressure to be generated by the region I and transferred to the evaluation point when a load is input into all load input points in the region I. Further, in each of the display sections 55, 56, 57, a distribution of each of the Q′/P, the Q′ and the P in a plurality of body panels, at a specific frequency designated by a cursor 58a, is displayed on a 3D model in such a manner that a level of a value of each of the Q′/P, the Q′ and the P is distinguishable by a color. The Q′ is calculated the transfer function (Q′/F) in a path from the load input point to the structure/sound coupling point, and the load input (F), in the formula (2-1), and the P/Q′ is calculated by the transfer function in a path from the structure/sound coupling point to the evaluation point in the formula (2-2). The P is calculated as a product of the P/Q′ and the Q′. The specific frequency can be interactively changed.

Further, based on a panel-vibration-suppression-effect estimation function, an improvement effect to be obtained by virtually suppressing a volume acceleration of a part of a vehicle body can be estimated. As shown in FIG. 14B, an arbitrary divided surface can be designated by a three-dimensional coordinate and a normal vector to set a selected region on the 3D model. In this case, an SPL-frequency curve 58c calculated in response to an operation of setting a volume acceleration in the selected region to zero or a certain lower level reduced by a given value, is displayed on the SPL-frequency display section 58 together with an SPL-frequency curve 58b created on a condition that a load is input into all the load input points in the region I, in a superimposed manner. The SPL-frequency curve 58c is calculated under a condition that the scale coefficient Wⱼ for the structure/sound coupling point j is set to zero or a lower level reduced by a given value, in the formula (2-1).

For example, based on the above function, a SPL-frequency characteristic of an upper portion of a vehicle body which is calculated in response to an operation of setting a volume acceleration in an under portion of the vehicle body to zero or a lower level reduced by a given value, can be checked. This means that an improvement effect to be obtained by virtually reducing a volume acceleration in a part of the body panels can be estimated.

[Panel-Region Contribution Analysis Screen]

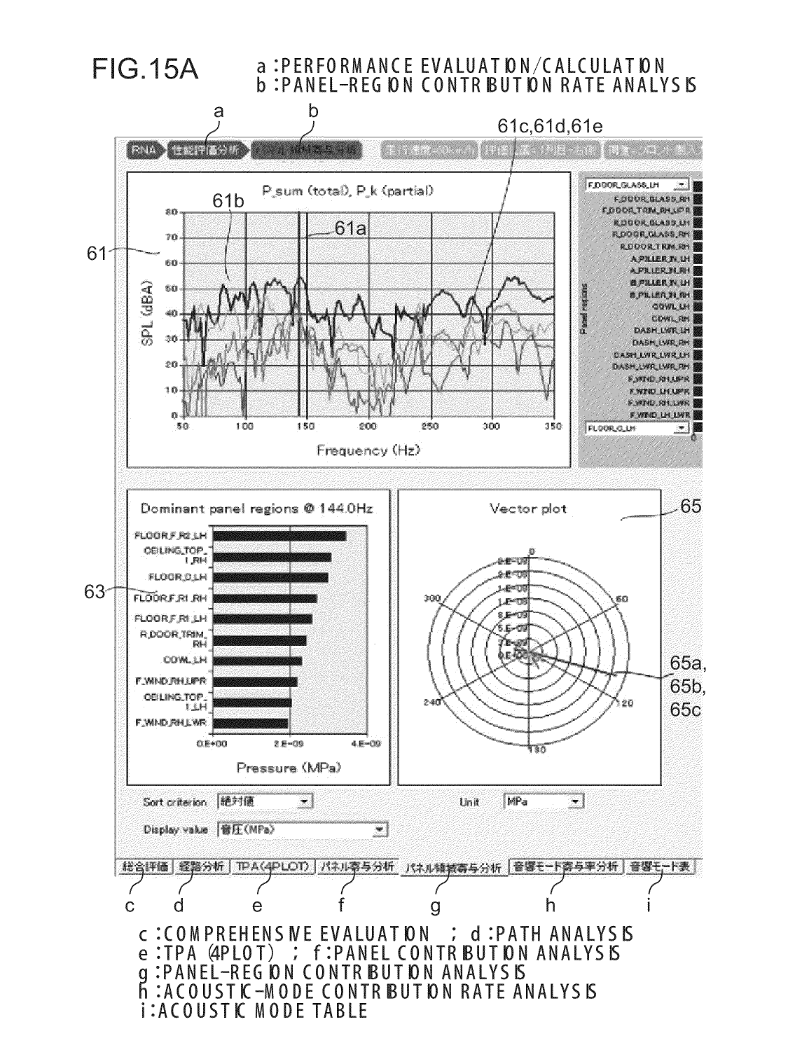

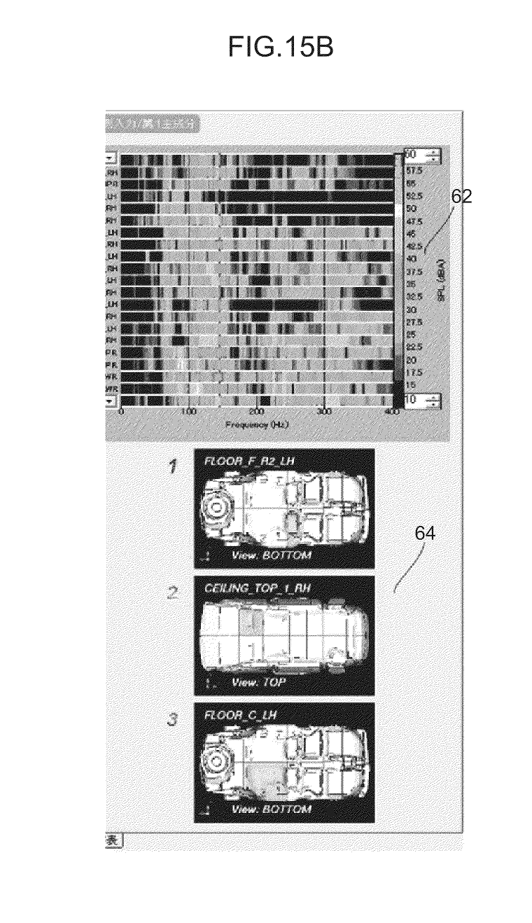

Upon selecting an item “Performance evaluation/analysis-Panel-region contribution analysis”, a panel-region contribution analysis screen as shown in FIG. 15 is displayed. In the panel-region contribution analysis screen, one or more panel regions selected in descending order of the contribution at a specific frequency are displayed. The specific frequency can be interactively changed.

In the panel-region contribution analysis screen, a region-by-region panel contribution analysis function can be utilized. For example, based on the region-by-region panel contribution analysis function, a body panel, such as a floor panel, constituting a vehicle body, can be arbitrarily divided into a plurality of panel regions to identify one or more of the panel regions having a large acoustic radiation amount, and analyze a phase relationship between the panel regions.

On a left upper side of the panel-region contribution analysis screen, an SPL-frequency curve display section 61 is displayed, as with the aforementioned path analysis screen. Specifically, the SPL-frequency curve display section 61 is configured to display an SPL-frequency curve 61b of a total sound to be generated by the region I and transferred to the evaluation point when a load is input into all the load input points in the region I, and three SPL-frequency curves 61c, 61d, 61e for respective ones of top-three panel regions selected in descending order of the contribution or the absolute value of a sound pressure, at a specific frequency designed by a cursor 61a. For example, the SPL-frequency curve display section 61 can be used to identify a panel region, such as a right region of a floor panel, having a relatively high contribution to a total sound pressure or a relatively large absolute value of a sound pressure, and check a SPL-frequency characteristic of the identified panel region. On a right side of the SPL-frequency curve display section 61, a body panel region-by-body panel region sound spectrogram display section 62 is displayed. The sound spectrogram display section 62 makes it possible to readily analyze one or more panel regions selected in descending order of the contribution at each of a plurality of specific frequencies.

Further, in a display section 63 on a lower side of the panel-region contribution analysis screen, contributions of a plurality of panel regions at a specific frequency designated by the cursor 61a in the SPL-frequency curve display section 61 are indicated in descending order of the contribution or the absolute value of sound pressure, in the form of a bar graph.

Then, top-three of the panel regions are displayed on a display section 64 on a right side of the display section 63 in the form of a 3D model.

Further, in order to clarify a relationship between phases of the top-three panel regions and a relationship between the absolute values of sound pressures of the top-three panel regions, each of the phases and of the top-three panel regions is indicated by a length of a straight line (65a, 65b, 65c) and each of the absolute values of sound pressures of the top-three panel regions is indicated by an angle of the straight line, in a vector diagram display section 65 illustrated in a lower middle region of FIG. 15.

The above data is calculated by setting by the formulas (3-1), (3-2) and (3-3) using the specific frequency as a frequency-dependent transfer function. The body panel is defined as the region L consisting of a set of panel regions I. This means that the region L can be arbitrarily set without being limited to a divided body panel in design, i.e., the body panel can be set as a divided body panel having an arbitrary size or configuration.

As above, the panel-region contribution analysis screen can be used to check a level of the contribution rate of each of a plurality of panel regions and a relationship between phases of the panel regions to readily identify a panel region or a body panel having an impact on vehicle interior sound.

[Acoustic-Mode Contribution Rate Analysis Screen]

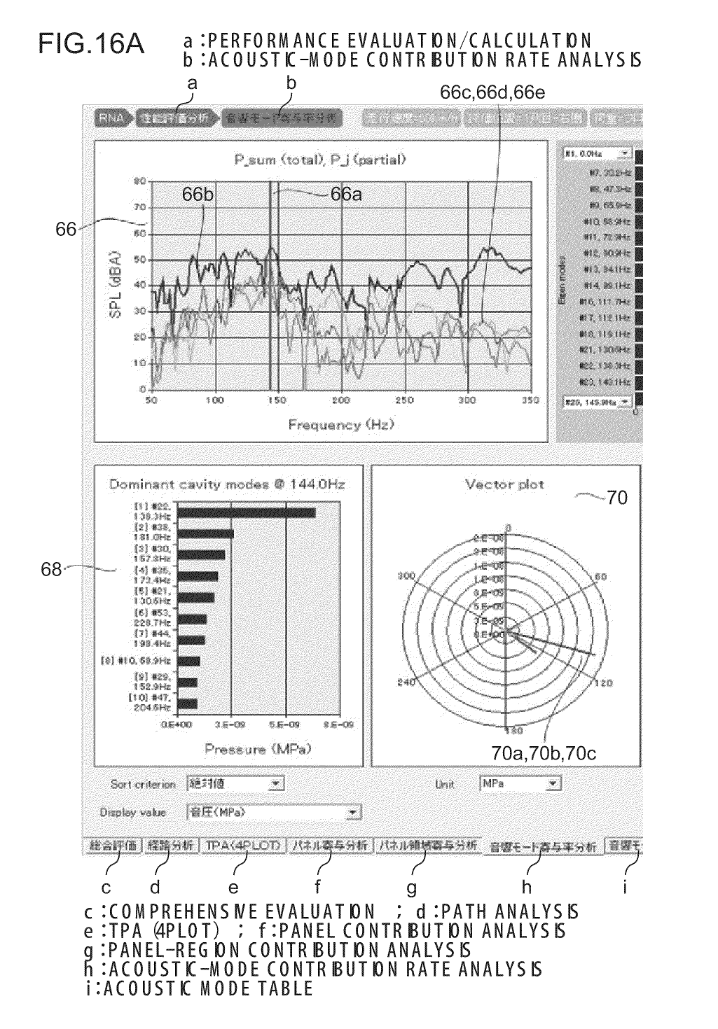

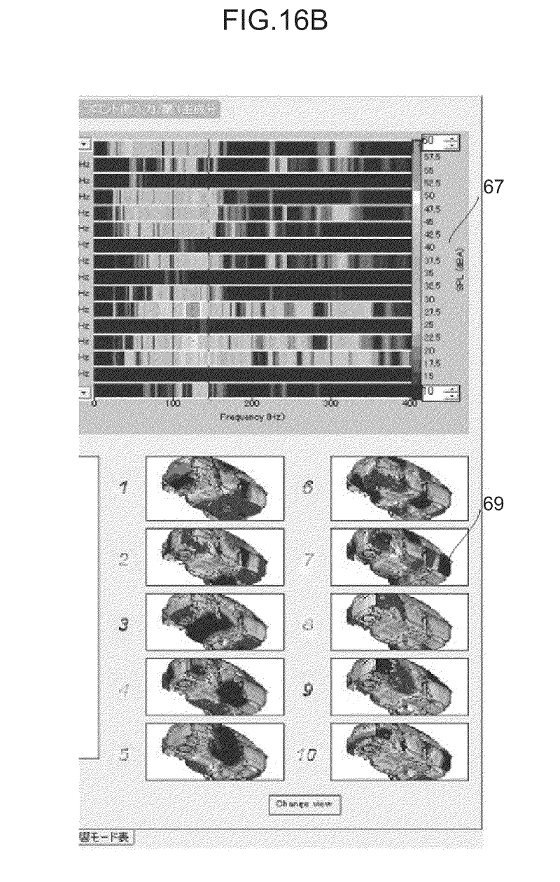

Upon selecting an item “Performance evaluation/analysis-Acoustic-mode contribution rate analysis, an acoustic-mode contribution rate analysis screen as shown in FIG. 16 is displayed. In the acoustic-mode contribution rate analysis screen, one or more acoustic modes selected in descending order of the contribution at a specific frequency are displayed. The specific frequency can be interactively changed.

In the acoustic-mode contribution rate analysis screen, a contribution of resonance coupling between the body panel and the acoustic mode, i.e., a contribution of a vehicle interior cavity resonance mode, can be analyzed. Vehicle interior sound can be improved by separating a resonance system causing high vehicle interior sound due to the resonance coupling. On a left upper side of the acoustic-mode contribution rate analysis screen, an SPL-frequency curve display section 66 is displayed, as with the aforementioned path analysis screen. Specifically, the SPL-frequency curve display section 66 is configured to display an SPL-frequency curve 66b of a total sound to be generated by the region I and transferred to the evaluation point when a load is input into all the load input points in the region I, and three SPL-frequency curves 66c, 66d, 66e for respective ones of top-three acoustic modes selected in descending order of the contribution or the absolute value of a sound pressure, at a specific frequency designed by a cursor 66a.

For example, the SPL-frequency curve display section 66 can be used to identify an acoustic mode, such as a 138 Hz mode at a specific frequency of 144 Hz, having a relatively high contribution to a sound pressure or a relatively large absolute value of a sound pressure, and check a SPL-frequency characteristic of the identified acoustic mode. On a right side of the SPL-frequency curve display section 66, an acoustic mode-by-acoustic mode sound spectrogram display section 67 is displayed. The sound spectrogram display section 67 makes it possible to readily analyze one or more acoustic modes selected in descending order of the contribution at each of a plurality of specific frequencies.

The sound having a frequency of 144 Hz is formed such that a vibration wave having a frequency of 138 Hz, a vibration wave having a frequency of 181 Hz, a vibration wave having a frequency of 157 Hz, and others, are superimposed together, wherein the vibration waves are different in the number of “anti-nodes” and “nodes”. Thus, vibration waves forming the 144 Hz are called “a 138 Hz mode, a 181 Hz mode, a 157 Hz mode, - - - -, respectively. Among them, top-ten vibration waves selected in descending order of the contribution are displayed in the form of a 3D image (see a display section 69 in FIG. 16).

Further, in a display section 68 on a lower side of the acoustic-mode contribution rate analysis screen, contributions of a plurality of acoustic modes at a specific frequency designated by the cursor 66a in the SPL-frequency curve display section 66 are indicated in descending order of the contribution or the absolute value of sound pressure, in the form of a bar graph. Then, top-ten of the acoustic modes are displayed on a display section 69 on a right side of the display section 68 in the form of a 3D model, as vehicle interior cavity resonance modes. Further, in order to clarify, at each of a plurality of specific frequency, a relationship between phases of the top-ten acoustic modes and a relationship between the absolute values of sound pressures of the top-ten acoustic modes, each of the phases and of the top-ten acoustic modes is indicated by a length of a straight line (70a, 70b, 70c) and each of the absolute values of sound pressures of the top-ten acoustic modes is indicated by an angle of the straight line, in a vector diagram display section 70 illustrated in a lower middle region of FIG. 16.

The above data is calculated by setting by the formulas (4-1), (4-2) and (4-3) using the specific frequency as a frequency-dependent transfer function.

As above, the acoustic-mode contribution rate analysis screen can be used to check a level of the contribution rate of each of a plurality of acoustic modes and a relationship between phases of the acoustic modes to readily identify an acoustic mode having an impact on vehicle interior sound.

The vehicle acoustic analysis apparatus according to the above embodiment makes it possible to improve efficiency in product development by utilizing various analysis functions thereof.

In summary, according to a first aspect of the present invention, there is provided an acoustic analysis apparatus for a vehicle, which comprises: a load setting section operable, in response to a user's instruction, to set, onto a structure representing the vehicle, a plurality of load input points corresponding to respective sound input sources; an evaluation-point setting section operable, in response to a user's instruction, to set, within a vehicle interior space of the structure, an evaluation point for evaluating a level of a sound pressure transferred from each of the set load input points; a calculation section operable to calculate a sound pressure level-frequency characteristic of a sound pressure from each of a plurality of paths between respective ones of the load input points and the evaluation point, over a given frequency range by a finite element method; and a display section operable to display the sound pressure level-frequency characteristic obtained by the calculation section, in such a manner as to distinguishably indicate a difference in sound pressure level between the respective sound pressures from the paths, at each frequency in the given frequency range.

The acoustic analysis apparatus of the present invention makes it possible to perform a detailed analysis at a specific frequency, while figuring out a sound-pressure distribution characteristic over a given acoustic frequency range.

Preferably, in the acoustic analysis apparatus of the present invention, the calculation section includes a sub-section operable to calculate a contribution of a sound pressure component at each of the load input points to a total sound pressure to be obtained by adding the sound pressures from all of the paths, wherein the display section is operable to display the contribution on a path-by-path basis.

In this preferred embodiment, it becomes possible to figure out a level of the sound pressure on a path-by-path basis.

Preferably, the above acoustic analysis apparatus further comprises a path-by-path sound-pressure-level changing section operable, in response to a user's instruction, to change a sound pressure level on a path-by-path basis, and wherein the display section is operable to display a sound pressure level-frequency characteristic calculated based on each of the changed sound pressure levels, on a path-by-path basis.

In this preferred embodiment, it becomes possible to, based on an operation of changing a level of a sound pressure transferred from a certain one of the paths, estimate effects of the change on a total sound pressure and respective sound pressures from the remaining paths.

Preferably, the acoustic analysis apparatus of the present invention further comprises an analysis-region setting section operable, in response to a user's instruction, to set an analysis region onto the structure, wherein the display section is operable to display a sound pressure level-frequency characteristic calculated in response to an operation of setting a sound pressure or a volume acceleration in the set analysis region to zero or a lower level reduced by a given value.

In this preferred embodiment, it becomes possible to figure out an effect of a modification to the structure, for example, a certain body panel thereof.

Preferably, in the above acoustic analysis apparatus, the analysis-region setting section is operable to set the analysis region in response to a user's instruction for designating a divided surface of the structure.

In this preferred embodiment, it becomes possible to facilitate setting of the analysis region.

Preferably, in the acoustic analysis apparatus of the present invention the calculation section is operable to calculate a sound pressure level-frequency characteristic over the given frequency range for each of a plurality of body panels of a vehicle body constituting the structure, and calculate a contribution of each of the body panels to the total sound pressure from all of the paths, and the display section is operable to display one or more of the body panels selected in descending order of the contribution at a specific frequency in the given frequency range

In this preferred embodiment, it becomes possible to figure out a sound pressure distribution on a body panel-by-body panel basis, to determine one or more of the body panels to be modified.

Preferably, in the acoustic analysis apparatus of the present invention, the display section is operable to display at least one of a plurality of body panels of a vehicle body constituting the structure, wherein the at least one body panel is selected in descending order of one of an acoustic radiation coefficient representing a potential to generate sound when it is vibrated, a volume acceleration representing a state when it is vibrating air in the vehicle interior, and a contribution rate to a sound pressure, which is calculated by multiplication of the acoustic radiation coefficient and the volume acceleration.

In this preferred embodiment, it becomes possible to figure out a panel having a relatively large acoustic radiation coefficient or volume acceleration, to determine one or more of the body panels to be modified.

Preferably, in the acoustic analysis apparatus of the present invention, the display section is operable to display an acoustic mode selected in descending order of contribution to a sound pressure at each frequency in the given frequency range.

In this preferred embodiment, it becomes possible to analyze a contribution of a resonance coupling between the body panel and the acoustic node, i.e., a contribution of a vehicle interior cavity resonance mode, and effectively take measures to reduce vehicle interior sound by separating a resonance system causing high vehicle interior sound due to the resonance coupling.

This application is based on Japanese Patent Application Serial No. 2009-080286 filed in Japan Patent Office on Mar. 27, 2009, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An acoustic analysis apparatus for a vehicle, comprising:
a load setting section operable, in response to a user's instruction, to set, onto a structure representing the vehicle, a plurality of load input points corresponding to respective sound input sources;
an evaluation-point setting section operable, in response to a user's instruction, to set, within a vehicle interior space of the structure, an evaluation point for evaluating a level of a sound pressure transferred from each of the set load input points;
a calculation section operable to calculate a sound pressure level-frequency characteristic of a sound pressure from each of a plurality of paths between respective ones of the load input points and the evaluation point, over a given frequency range by a finite element method; and
a display section operable to display the sound pressure level-frequency characteristic obtained by the calculation section, in such a manner as to distinguishably indicate a difference in sound pressure level between the respective sound pressures from the paths, at each frequency in the given frequency range.

2. The acoustic analysis apparatus as defined in claim 1, wherein the calculation section includes a sub-section operable to calculate a contribution of a sound pressure component at each of the load input points to a total sound pressure to be obtained by adding the sound pressures from all of the paths, and wherein the display section is operable to display the contribution on a path-by-path basis.

3. The acoustic analysis apparatus as defined in claim 2, which further comprises a path-by-path sound-pressure-level changing section operable, in response to a user's instruction, to change a sound pressure level on a path-by-path basis, and wherein the display section is operable to display a sound pressure level-frequency characteristic calculated based on each of the changed sound pressure levels, on a path-by-path basis.

4. The acoustic analysis apparatus as defined in claim 1, which further comprises an analysis-region setting section operable, in response to a user's instruction, to set an analysis region onto the structure, and wherein the display section is operable to display a sound pressure level-frequency characteristic calculated in response to an operation of setting a sound pressure or a volume acceleration in the set analysis region to zero or a lower level reduced by a given value.

5. The acoustic analysis apparatus as defined in claim 4, wherein the analysis-region setting section is operable to set the analysis region in response to a user's instruction for designating a divided surface of the structure.

6. The acoustic analysis apparatus as defined in claim 1, wherein:
the calculation section is operable to calculate a sound pressure level-frequency characteristic over the given frequency range for each of a plurality of body panels of a vehicle body constituting the structure, and calculate a contribution of each of the body panels to the total sound pressure from all of the paths; and
the display section is operable to display one or more of the body panels selected in descending order of the contribution at a specific frequency in the given frequency range

7. The acoustic analysis apparatus as defined in claim 1, wherein the display section is operable to display at least one of a plurality of body panels of a vehicle body constituting the structure, wherein the at least one body panel is selected in descending order of one of an acoustic radiation coefficient representing a potential to generate sound when it is vibrated, a volume acceleration representing a state when it is vibrating air in the vehicle interior, and a contribution rate to a sound pressure, which is calculated by multiplication of the acoustic radiation coefficient and the volume acceleration.

8. The acoustic analysis apparatus as defined in claim 1, wherein the display section is operable to display an acoustic mode selected in descending order of contribution to a sound pressure at each frequency in the given frequency range.

9. The acoustic analysis apparatus as defined in claim 8, wherein the display section is operable to display a pattern of the acoustic mode selected in descending order of contribution to a sound pressure at each frequency in the given frequency range.

10. A method of controlling an acoustic analysis apparatus for a vehicle, comprising:
a load setting step of setting, onto a structure representing the vehicle, a plurality of load input points corresponding to respective sound input sources;
an evaluation-point setting step of setting, within a vehicle interior space of the structure, an evaluation point for evaluating a level of a sound pressure transferred from each of the set load input points;
a calculation step of calculating a sound pressure level-frequency characteristic of a sound pressure from each of a plurality of paths between respective ones of the load input points and the evaluation point, over a given frequency range by a finite element method; and
a display step of displaying the sound pressure level-frequency characteristic obtained in the calculation step, in such a manner as to distinguishably indicate a difference in sound pressure level between the respective sound pressures from the paths, at each frequency in the given frequency range.

11. A recording medium storing a program for causing an acoustic analysis apparatus for a vehicle to perform a process comprising:
setting, onto a structure representing the vehicle, a plurality of load input points corresponding to respective sound input sources;
setting, within a vehicle interior space of the structure, an evaluation point for evaluating a level of a sound pressure transferred from each of the set load input points;
calculating a sound pressure level-frequency characteristic of a sound pressure from each of a plurality of paths between respective ones of the load input points and the evaluation point, over a given frequency range by a finite element method; and
displaying the sound pressure level-frequency characteristic obtained by the calculation, in such a manner as to distinguishably indicate a difference in sound pressure level between the respective sound pressures from the paths, at each frequency in the given frequency range.

12. An acoustic analysis apparatus for a vehicle, comprising:
load setting means for, in response to a user's instruction, setting, onto a structure representing the vehicle, a plurality of load input points corresponding to respective sound input sources;
evaluation-point setting means for, in response to a user's instruction, setting, within a vehicle interior space of the structure, an evaluation point for evaluating a level of a sound pressure transferred from each of the set load input points;
calculation section means for calculating a sound pressure level-frequency characteristic of a sound pressure from each of a plurality of paths between respective ones of the load input points and the evaluation point, over a given frequency range by finite element method; and
display means for displaying the sound pressure level-frequency characteristic obtained by the calculation means, in such a manner as to distinguishably indicate a difference in sound pressure level between the respective sound pressures from the paths, at each frequency in the given frequency range.
